(19) United States
(12) Patent Application Publication
(10) Pub. No.: US 2026/0082061 A1
(43) Pub. Date: Mar. 19, 2026

(54) TRANSMISSION BANDWIDTH ALLOCATION METHOD AND COMMUNICATION DEVICE

(71) Applicant: Realtek Semiconductor Corp., HsinChu (TW)

(72) Inventor: Yueh-Hsing Huang, HsinChu (TW)

(73) Assignee: Realtek Semiconductor Corp., Hsinchu (TW)

(21) Appl. No.: 19/015,571

(22) Filed: Jan. 9, 2025

(30) Foreign Application Priority Data
Sep. 18, 2024 (TW) 113135199

(51) Int. Cl. H04N 19/177; G10L 19/002; H04N 19/159; H04N 19/172; H04N 19/593

(52) U.S. Cl. CPC H04N 19/177; G10L 19/002; H04N 19/159; H04N 19/172; H04N 19/593

(57) ABSTRACT

A transmission bandwidth allocation method includes: receiving, by a transmission device, requirement information from a reception device via a specific interface; transmitting, by the transmission device, attribute information corresponding to the requirement information to the reception device via the specific interface; and dynamically allocating, by the transmission device, a transmission bandwidth according to the attribute information for transmitting multiple data to the reception device.

### BACKGROUND OF THE INVENTION

### 1. Field of the Invention

The present invention is related to bandwidth configuration, and more particularly, to a transmission bandwidth allocation method for dynamically allocating a transmission bandwidth according to information from a reception device, and an associated communication device.

### 2. Description of the Prior Art

A conventional electronic device with a point-to-point (i.e., one-to-one) data transmission function adopts a fixed quota bandwidth configuration for data transmitting. This means that the maximum bandwidth requirement of all application scenarios is adopted for transmission bandwidth configuration of different types of data, which causes lower bandwidth utilization efficiency. For example, during a certain time period, the actual amount of transmitted data may be much lower than the total transmission bandwidth, resulting in a waste of bandwidth.

### SUMMARY OF THE INVENTION

It is therefore one of the objectives of the present invention to provide a transmission bandwidth allocation method and an associated communication device for dynamically allocating a transmission bandwidth according to information from a reception device, in order to address the above-mentioned issues.

According to an embodiment of the present invention, a transmission bandwidth allocation method is provided. The transmission bandwidth allocation method comprises: receiving, by a transmission device, requirement information from a reception device via a specific interface; transmitting, by the transmission device, attribute information corresponding to the requirement information to the reception device via the specific interface; and dynamically allocating, by the transmission device, a transmission bandwidth according to the attribute information for transmitting multiple data to the reception device.

According to an embodiment of the present invention, a communication device is provided. The communication device comprises a communication module and a data transmission management module. The communication module is arranged to receive requirement information from a reception device via a specific interface, and transmit attribute information corresponding to the requirement information to the reception device via the specific interface. The data transmission management module is arranged to dynamically allocate a transmission bandwidth according to the attribute information for transmitting multiple data to the reception device.

The transmission bandwidth allocation method and the transmission device of the present invention can dynamically allocate a transmission bandwidth according to requirement information (e.g., video information, audio information, auxiliary data information, and/or Ethernet information) from a reception device, such that the transmission bandwidth usage of a specific interface (e.g., an Ethernet or an optical fiber) connected between the transmission device and the reception device can be optimized/maximized.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a data transceiving system according to an embodiment of the present invention.

FIG. 2 is a diagram illustrating a transmission device according to an embodiment of the present invention.

FIG. 3 is a flow chart of a transmission bandwidth allocation method according to an embodiment of the present invention.

FIG. 4 is a diagram illustrating an example of performing transmission bandwidth allocation based on a group of pictures (GOP) by the transmission device shown in FIG. 1 according to an embodiment of the present invention.

FIG. 5 is a diagram illustrating an example of performing transmission bandwidth allocation based on the GOP and enabling/disabling of an audio function by the transmission device shown in FIG. 1 according to an embodiment of the present invention.

### DETAILED DESCRIPTION

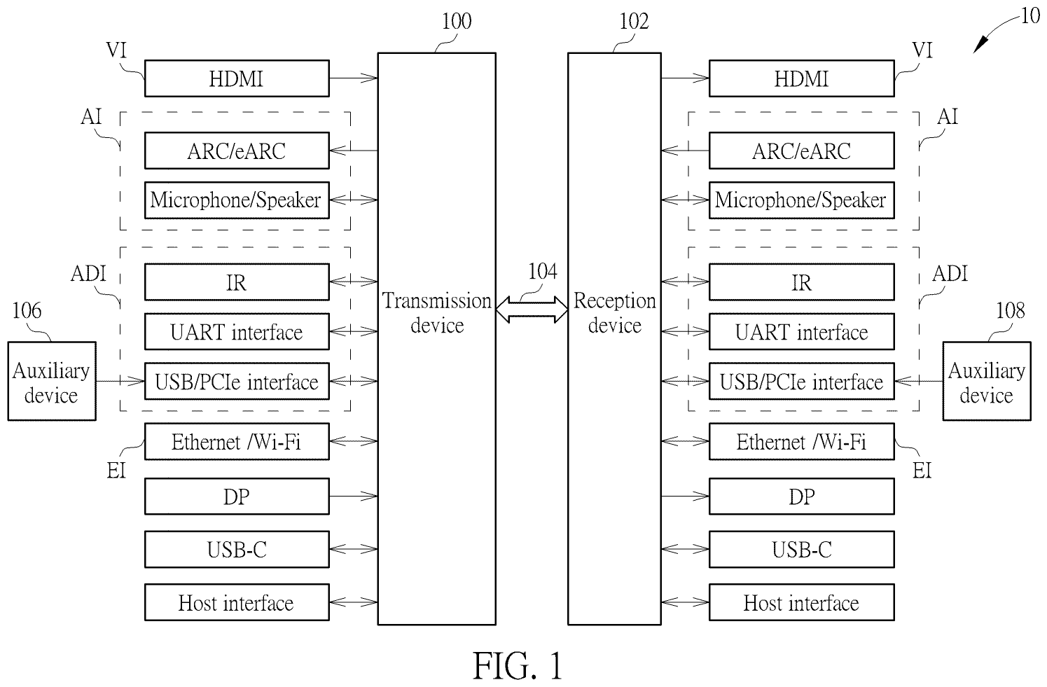

FIG. 1 is a diagram illustrating a data transceiving system 10 according to an embodiment of the present invention. As shown in FIG. 1, the data transceiving system 10 has a point-to-point (i.e., one-to-one) data transceiving function, and includes a transmission device 100 and a reception device 102, wherein both the transmission device 100 and the reception device 102 may be implemented by a communication device. The transmission device 100 may perform communications (e.g., data transceiving) with the reception device 102 via a specific interface 104, wherein the specific interface 104 may be an Ethernet or an optical fiber. Both the transmission device 100 and the reception device 102 have multiple internal interfaces for providing different signal transceiving functions and/or external device coupling functions. Examples of the internal interfaces may include, but are not limited to: a High Definition Multimedia Interface (HDMI), a DisplayPort (DP), an audio transmission interface with an audio return channel (ARC) function and/or an enhanced ARC (eARC) function, a Peripheral Component Interconnect Express (PCIe) interface, a Universal Serial Bus (USB) interface, a USB type-C (USB-C) interface, and a host interface.

In this embodiment, auxiliary devices 106 and 108 may be respectively coupled to the transmission device 100 and the reception device 102 via the USB/PCIe interface. Examples of the auxiliary devices 106 and 108 may include, but are not limited to: a keyboard, a mouse, a disk, a webcam, a microphone, and a speaker.

The transmission device 100 may transmit multiple data to the reception device 102 by utilizing a transmission bandwidth provided by the specific interface 104. In order to optimize/maximize the transmission bandwidth usage, the transmission device 100 may receive a packet carrying requirement information from the reception device 102 via the specific interface 104, wherein the requirement information may indicate functions to be enabled/disabled (e.g., a video function, an audio function, and an auxiliary function) and data to be received (e.g., video data, audio data, and a control signal of the auxiliary device 108) of the reception device 102. Afterwards, the transmission device 100 may transmit another packet carrying attribute information corresponding to the requirement information to the reception device 102 according to the received packet, and dynamically allocate the transmission bandwidth according to the attribute information for transmitting corresponding data to the reception device 102, wherein the attribute information may indicate whether the functions are enabled/disabled and/or related attributes of the transmitted data. Specifically, the requirement information may include at least one of video information VI, audio information AI, and auxiliary data information ADI. The video information VI may be a video output ability of the reception device 102, such as a video resolution, a frame rate, and a video format. The audio information AI may be an audio output ability of the reception device 102 (e.g., a speaker coupled to the reception device 102), such as a sampling rate, the number of channels, and a bit depth. The auxiliary data information ADI may be related information of an infrared (IR) receiver/transmitter and/or the auxiliary device 108 coupled to the reception device 102. It should be noted that, under a situation where the specific interface 104 is the optical fiber, the requirement information of the reception device 102 may further include Ethernet information EI for notifying the transmission device 100 of transmitting data related to the Ethernet/wireless fidelity (Wi-Fi) to the reception device 102.

In this embodiment, the video information VI is associated with HDMI video data, the audio information AI is associated with an ARC/eARC function and an audio output ability of the speaker or the microphone, and the auxiliary data information ADI is associated with an IR signal, a Universal Asynchronous Receiver/Transmitter (UART) interface (e.g., a Recommend Standard number 232 (RS232) interface), a USB/PCIe interface, and the auxiliary device 108 coupled to the reception device 102 via the USB/PCIe interface. This is for illustrative purposes only, and is not meant to be a limitation of the present invention.

In a case where the transmission device 100 receives the video information VI from the reception device 102 via the specific interface 104, the transmission device 100 may perform a video compression operation upon HDMI video data to be transmitted to the reception device 102 according to a video encoding standard (e.g., an AOMedia Video 1 (AV1) encoding standard) in order to generate a group of pictures (GOP), wherein the GOP at least includes an intra-frame (I-frame) and a predictive-frame (P-frame), and the above-mentioned attribute information is associated with the GOP.

Assume that the transmission bandwidth provided by the specific interface 104 includes a video bandwidth for transmitting the HDMI video data to the reception device 102. The transmission device 100 may dynamically allocate the video bandwidth in response to a generation frame in the GOP. A bit rate required by the I-frame is relatively greater than that required by the P-frame. In response to the generation frame being the I-frame, the transmission device 100 may allocate a first bandwidth for transmitting the HDMI video data to the reception device 102. In response to the generation frame being the P-frame, the transmission device 100 may allocate a second bandwidth for transmitting the HDMI video data to the reception device 102, wherein the second bandwidth is less than the first bandwidth. As a result, when the P-frame is generated, the transmission device 100 may allocate a remaining bandwidth for transmitting other data (e.g., the audio data and the control signal of the auxiliary device 108) to the reception device 102, wherein the remaining bandwidth is a difference value between the first bandwidth and the second bandwidth. It should be noted that, under a situation where the specific interface 104 is the optical fiber, the transmission device 100 may also utilize the remaining bandwidth to transmit related data of the Ethernet/Wi-Fi to the reception device 102.

In a case where the transmission device 100 receives the audio information AI from the reception device 102 via the specific interface 104, the audio information AI may indicate whether an audio function (e.g., the ARC function and the eARC function) is enabled, and the transmission device 100 may dynamically allocate the transmission bandwidth according to attribute information associated with the audio function. For example, when the audio information AI indicates that the audio function is enabled, the transmission device 100 may allocate a portion of the transmission bandwidth to the audio function (e.g., allocate the bandwidth originally used for transmitting other data to the audio function). When the audio information AI indicates that the audio function is disabled, the transmission device 100 may utilize the bandwidth corresponding to the audio function in the transmission bandwidth to transmit other data to the reception device 102.

In addition, the audio information AI may further indicate related attributes of the audio data (e.g., the number of channels, the bit depth, and the sampling rate). For example, initially, the audio information AI indicates the transmission device 100 to transmit audio data with 8 channels, 24-bit depth, and 196 KHz sampling rate to the reception device 102 (i.e., the audio data requires a bit rate with approximately 36 million bits per second (Mbps)), and the transmission device 100 may allocate a bandwidth with 50 Mbps for transmitting the audio data. Afterwards, if the audio information AI is modified to indicate the transmission device 100 to transmit audio data with 2 channels, 16-bit depth, and 48 KHz sampling rate to the reception device 102 (i.e., the audio data requires approximately a bit rate with approximately 1.5 Mbps), the transmission device 100 may be modified to allocate a bandwidth with 2 Mbps for transmitting the audio data. As a result, the transmission device 100 may utilize the remaining bandwidth (e.g., the bandwidth with 48 Mbps) to transmit other data.

Under a case where the transmission device 100 receives the auxiliary data information ADI from the reception device 102 via the specific interface 104, the auxiliary data information ADI may indicate related attributes of the auxiliary data (e.g., the USB interface, the IR signal, and the UART interface), and the transmission device 100 may dynamically allocate a bandwidth for transmitting the control signal related to the auxiliary data according to the related attributes. Take the USB interface as an example. The USB interface has multiple modes, including a human interface device (HID) mode for the coupling device (e.g., the keyboard and the mouse), an isochronous mode for transmitting the audio signal, and a bulk mode for transmitting data of a storage device (e.g., a USB). Each of the modes has a corresponding attribute, and the transmission device 100 may dynamically allocate a bandwidth for transmitting the control signal related to the USB interface according to the corresponding attribute.

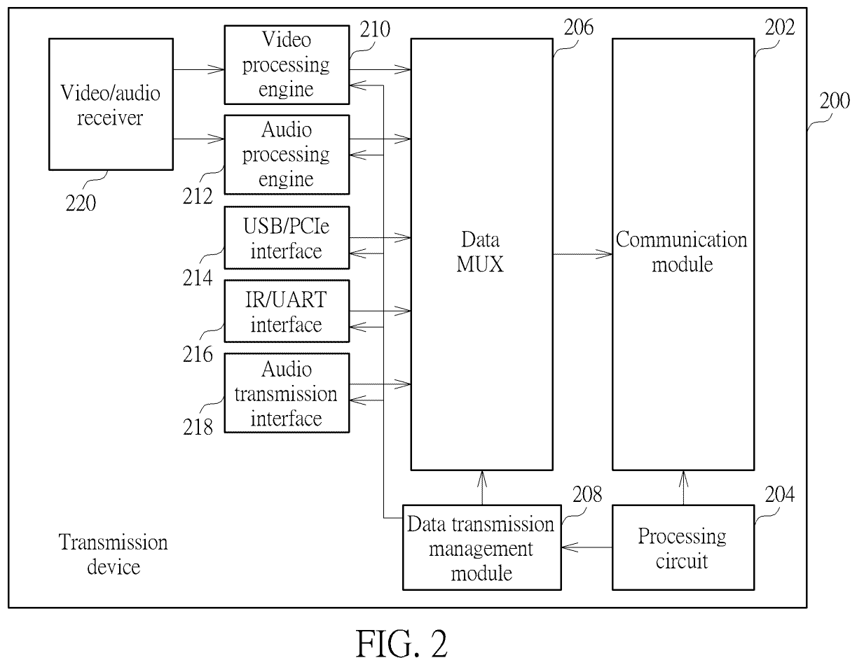

FIG. 2 is a diagram illustrating a transmission device 200 according to an embodiment of the present invention, wherein the transmission device 100 shown in FIG. 1 may be implemented by the transmission device 200. As shown in FIG. 2, the transmission device 200 may include a communication module 220, a processing circuit 204, a data multiplexer (MUX) 206, a data transmission management module 208, a video processing engine 210, an audio processing engine 212, a USB/PCIe interface 214, an IR signal control and/or UART interface 216 (for brevity, denoted by “IR/UART interface”), an audio transmission interface 218, and a video/audio receiver 220. The communication module 202 may be an Ethernet module or an optical fiber module, and may include communication circuits for performing communications with a reception device via a communication interface (e.g., the specific interface 104 shown in FIG. 1). The processing circuit 204 may establish an intranet with the reception device via the communication module 202. During the process of establishing the intranet, the transmission device 200 may perform a handshake operation with the reception device in order to exchange messages and perform identity verification.

In addition, external devices (e.g., the USB, the webcam, the keyboard, the mouse, the speaker, and the microphone) may be coupled to the transmission device 200 via the USB/PCIe interface 214 for acting as auxiliary devices. The IR/UART interface 216 may include an IR transmitter/receiver and/or a UART transmission interface for providing transceiving functions of bi-directional IR control signals and/or UART control signals. The audio transmission interface 218 may be equipped with the ARC/eARC function. The video/audio receiver 220 may be an HDMI receiver and/or a DP receiver, and may be arranged to receive video data from an external video signal source. The video processing engine 210 and the audio processing engine 212 may process the video data (e.g., perform a format conversion upon the video data), and provide the processed video data to the data MUX 206. The data MUX 206 may be coupled to the video processing engine 210, the audio processing engine 212, the USB/PCIe interface 214, the IR/UART interface 216, and the audio transmission interface 218, and may be arranged to perform data multiplexing and de-multiplexing between the above-mentioned engines/interfaces and the communication module 202.

In this embodiment, the communication module 202 may receive requirement information from the reception device via the specific interface 104, and transmit attribute information corresponding to the requirement information to the reception device for establishing the intranet. The data transmission management module 208 may include related circuits that can dynamically allocate the transmission bandwidth provided by the specific interface 104 according to the attribute information. For example, the data transmission management module 208 may be arranged to dynamically allocate a bandwidth for transmitting the video data according to attribute information associated with the GOP, and utilize the remaining bandwidth for transmitting other data. In another example, the data transmission management module 208 may be arranged to dynamically allocate a bandwidth corresponding to an audio function according to attribute information associated with the audio function, and utilize a corresponding bandwidth for transmitting other data when the audio function is disabled. It should be noted that, under a situation where the communication module 202 is an optical fiber module, the requirement information of the reception device may further include Ethernet information EI, and the data transmission management module 208 may be further arranged to dynamically allocate a bandwidth corresponding to the Ethernet according to attribute information associated with the Ethernet. Since the transmission bandwidth dynamic allocation of the data transmission management module 208 has been illustrated in the above paragraphs, similar descriptions are not repeated in detail here.

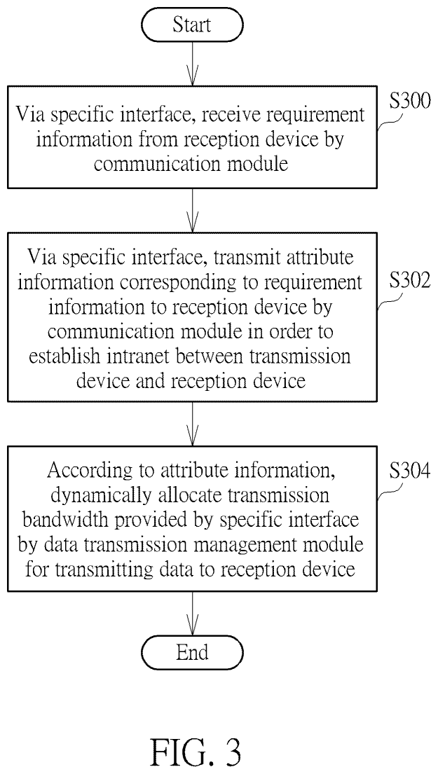

FIG. 3 is a flow chart of a transmission bandwidth allocation method according to an embodiment of the present invention. Provided that the result is substantially the same, the steps are not required to be executed in the exact order shown in FIG. 3. For example, the transmission bandwidth allocation method shown in FIG. 3 may be performed by the transmission device 100 shown in FIG. 1 and/or the transmission device 200 (more particularly, the communication module 202 and the data transmission management module 208) shown in FIG. 2.

In Step S300, via the specific interface 104, requirement information is received from the reception device 102 by the communication module 202.

In Step S302, via the specific interface 104, attribute information corresponding to the requirement information is transmitted to the reception device 102 by the communication module 202 in order to establish the intranet between the transmission device 100/200 and the reception device 102.

In Step S304, according to the attribute information, a transmission bandwidth provided by the specific interface 104 is dynamically allocated by the data transmission management module 208 for transmitting data to the reception device 102.

Since a person skilled in the pertinent art can readily understand details of the steps after reading the above paragraphs, further description is omitted here for brevity.

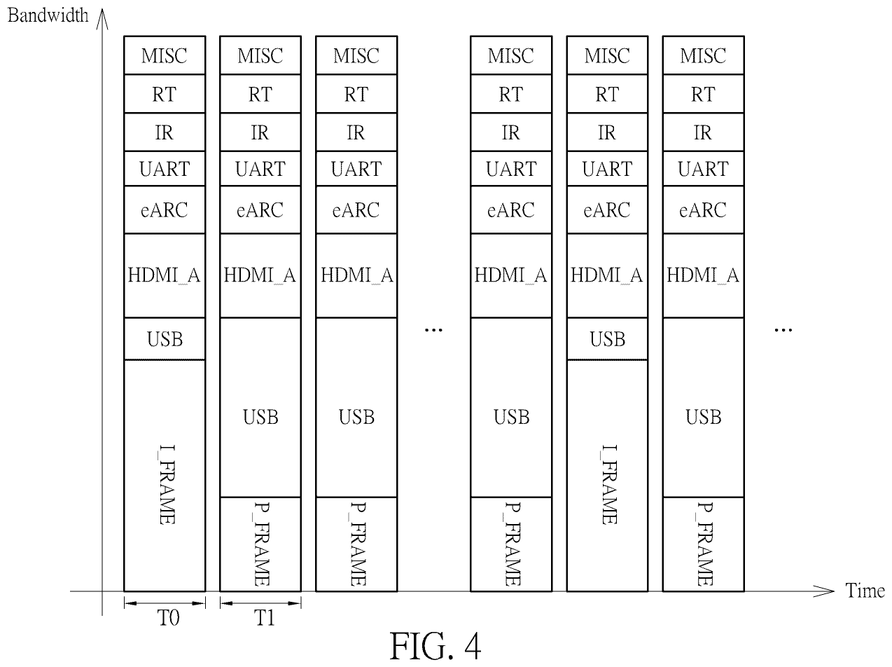

FIG. 4 is a diagram illustrating an example of performing transmission bandwidth allocation based on the GOP by the transmission device 100 shown in FIG. 1 according to an embodiment of the present invention. As shown in FIG. 4, the transmission device 100 may utilize the bandwidth provided by the specific interface 104 to transmit multiple data (e.g., real-time data (for brevity, labeled as “RT” in FIG. 4), HDMI video data, and HDMI audio data (for brevity, labeled as “HDMI_A” in FIG. 4)) to the reception device 102, and allocate a portion of the transmission bandwidth to the eARC function, the IR signal, the UART interface, and the USB interface. In addition, data, interfaces, and functions not mentioned above (e.g., the DP video data, the USB-C interface, and the host interface) are collectively referred to as remaining data (for brevity, labeled as “MSIC” in FIG. 4), and the transmission device 100 may also allocate another portion of the transmission bandwidth to the remaining data.

During a time period T0, in response to the attribute information associated with the GOP indicating that the generation frame in the GOP is the I-frame (labeled as “I_FRAME” in FIG. 4), the transmission device 100 may allocate a bandwidth B1 for transmitting the HDMI video data to the reception device 102. During a time period T1, in response to the attribute information associated with the GOP indicating that the generation frame in the GOP is the P-frame (labeled as “P_FRAME” in FIG. 4), the transmission device 100 may allocate a bandwidth B2 less than the bandwidth B1 for transmitting the HDMI video data to the reception device 102, and allocate a difference value between the bandwidths B1 and B2 (e.g., a bandwidth B3) to the USB interface. Since the transmission bandwidth allocation of the remaining time period is similar to that of the time periods T0 and T1, similar descriptions are not repeated in detail here.

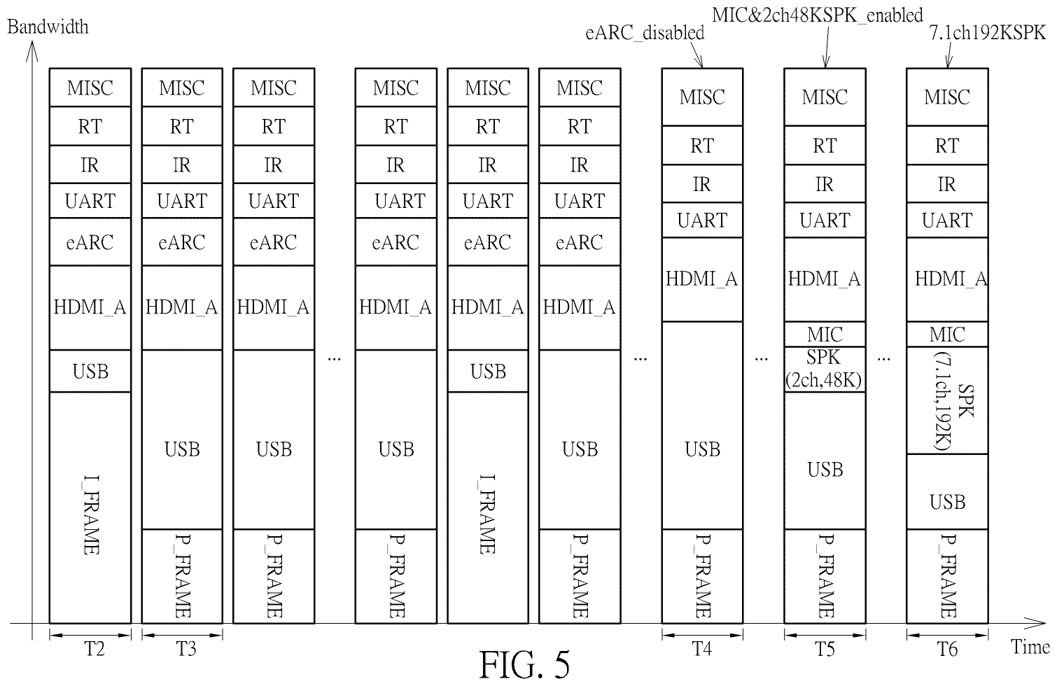

FIG. 5 is a diagram illustrating an example of performing transmission bandwidth allocation based on the GOP and enabling/disabling of an audio function by the transmission device 100 shown in FIG. 1 according to an embodiment of the present invention. As shown in FIG. 5, the transmission device 100 may utilize a transmission bandwidth provided by the specific interface 104 to transmit multiple data (e.g., real-time data (for brevity, labeled as “RT” in FIG. 5), HDMI video data, and HDMI audio data (for brevity, labeled as “HDMI_A” in FIG. 5)) to the reception device 102, and allocate a portion of the transmission bandwidth to the eARC function, the IR signal, the UART interface, and the USB interface. In addition, data, interfaces, and functions not mentioned above (e.g., the DP video data, the USB-C interface, and the host interface) are collectively referred to as remaining data (for brevity, labeled as “MSIC” in FIG. 5), and the transmission device 100 may also allocate another portion of the transmission bandwidth to the remaining data.

During a time period T2, in response to the attribute information associated with the GOP indicating that the generation frame in the GOP is the I-frame (labeled as “I_FRAME” in FIG. 5), the transmission device 100 may allocate a bandwidth B1 for transmitting the HDMI video data to the reception device 102. During a time period T3, in response to the attribute information associated with the GOP indicating that the generation frame in the GOP is the P-frame (labeled as “P_FRAME” in FIG. 5), the transmission device 100 may allocate a bandwidth B2 less than the bandwidth B1 for transmitting the HDMI video data to the reception device 102, and allocate a difference value between the bandwidths B1 and B2 (e.g., a bandwidth B3) to the USB interface. During a time period T4, according to the requirement information from the reception device 102, the transmission device 100 may be notified that the eARC function is disabled (for brevity, labeled as “eARC_disabled” in FIG. 5). As a result, the transmission device 100 may release a bandwidth corresponding to the eARC function and allocate the bandwidth to the USB interface. During a time period T5, according to the requirement information from the reception device 102, the transmission device 100 may be notified that a microphone (labeled as “MIC” in FIG. 5) and a speaker with 2 channels and a 48 KHz sampling rate (labeled as “SPK(2 ch, 48K)” in FIG. 5) are enabled (for brevity, labeled as “MIC&2ch48KSPK_enabled” in FIG. 5), and may therefore allocate a portion of the bandwidth corresponding to the USB interface to the microphone and the speaker. During a time period T6, according to the requirement information from the reception device 102, the transmission device 100 may be notified that the speaker with 2 channels and a 48 KHz sampling rate is replaced by a speaker with 7.1 channels and a 192 KHz sampling rate, (for brevity, labeled as “7.1ch192KSPK” in FIG. 5), and may therefore allocate another portion of the bandwidth corresponding to the USB interface to the speaker.

In summary, the transmission bandwidth allocation method and the transmission device of the present invention can dynamically allocate a transmission bandwidth according to requirement information (e.g., the video information VI, the audio information AI, the auxiliary data information ADI, and/or the Ethernet information EI) from a reception device, such that the transmission bandwidth usage of a specific interface (e.g., an Ethernet or an optical fiber) connected between the transmission device and the reception device can be optimized/maximized.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A transmission bandwidth allocation method, comprising:
receiving, by a transmission device, requirement information from a reception device via a specific interface;
transmitting, by the transmission device, attribute information corresponding to the requirement information to the reception device via the specific interface; and
dynamically allocating, by the transmission device, a transmission bandwidth according to the attribute information for transmitting multiple data to the reception device.

2. The transmission bandwidth allocation method of claim 1, wherein the requirement information comprises at least one of video information, audio information, and auxiliary data information.

3. The transmission bandwidth allocation method of claim 2, wherein in response to the requirement information comprising the video information, a compression operation is performed upon a video data among the multiple data by the transmission device in order to generate a group of pictures (GOP), and the attribute information is associated with the GOP.

4. The transmission bandwidth allocation method of claim 3, wherein the GOP at least comprises an intra-frame and a predictive-frame, the transmission bandwidth comprises a video bandwidth for transmitting the video data, and the step of dynamically allocating the transmission bandwidth according to the attribute information for transmitting the multiple data to the reception device further comprises:
dynamically allocating the video bandwidth in response to a generation frame in the GOP, for transmitting the video data to the reception device.

5. The transmission bandwidth allocation method of claim 4, wherein the step of dynamically allocating the video bandwidth in response to the generation frame in the GOP comprises:
in response to the generation frame being the intra-frame, allocating a first bandwidth for transmitting the video data to the reception device; and
in response to the generation frame being the predictive-frame, allocating a second bandwidth for transmitting the video data to the reception device, wherein the second bandwidth is less than the first bandwidth.

6. The transmission bandwidth allocation method of claim 5, wherein the step of allocating the second bandwidth for transmitting the video data to the reception device comprises:
allocating a remaining bandwidth for transmitting remaining data among the multiple data to the reception device, wherein the remaining bandwidth is a difference value between the first bandwidth and the second bandwidth.

7. The transmission bandwidth allocation method of claim 2, wherein the requirement information comprises the audio information, the audio information indicates that an audio function is enabled, the attribute information is associated with the audio function, and the step of dynamically allocating the transmission bandwidth according to the attribute information for transmitting the multiple data to the reception device further comprises:
allocating a portion of the transmission bandwidth to the audio function.

8. The transmission bandwidth allocation method of claim 2, wherein the requirement information comprises the audio information, the audio information indicates that an audio function is disabled, the attribute information is associated with the audio function, and the step of dynamically allocating the transmission bandwidth according to the attribute information for transmitting the multiple data to the reception device further comprises:
via utilizing a bandwidth corresponding to the audio function in the transmission bandwidth, transmitting the multiple data to the reception device.

9. The transmission bandwidth allocation method of claim 1, wherein the specific interface is an Ethernet or an optical fiber.

10. The transmission bandwidth allocation method of claim 9, wherein the specific interface is the optical fiber, and the requirement information comprises at least one of video information, audio information, auxiliary data information, and Ethernet information.

11. A communication device, comprising:
a communication module, arranged to:
receive requirement information from a reception device via a specific interface; and
transmit attribute information corresponding to the requirement information to the reception device via the specific interface; and
a data transmission management module, arranged to dynamically allocate a transmission bandwidth according to the attribute information for transmitting multiple data to the reception device.

12. The communication device of claim 11, wherein the requirement information comprises at least one of video information, audio information, and auxiliary data information.

13. The communication device of claim 12, wherein in response to the requirement information comprising the video information, the communication module performs a compression operation upon a video data among the multiple data in order to generate a group of pictures (GOP), and the attribute information is associated with the GOP.

14. The communication device of claim 13, wherein the GOP at least comprises an intra-frame and a predictive-frame, the transmission bandwidth comprises a video bandwidth for transmitting the video data, and the data transmission management module is further arranged to dynamically allocate the video bandwidth in response to a generation frame in the GOP, for transmitting the video data to the reception device.

15. The communication device of claim 14, wherein in response to the generation frame being the intra-frame, the data transmission management module is further arranged to allocate a first bandwidth for transmitting the video data to the reception device; and in response to the generation frame being the predictive-frame, the data transmission management module is further arranged to allocate a second bandwidth for transmitting the video data to the reception device, wherein the second bandwidth is less than the first bandwidth.

16. The communication device of claim 15, wherein the data transmission management module is further arranged to allocate a remaining bandwidth for transmitting remaining data among the multiple data to the reception device, wherein the remaining bandwidth is a difference value between the first bandwidth and the second bandwidth.

17. The communication device of claim 12, wherein the requirement information comprises the audio information, the audio information indicates that an audio function is enabled, the attribute information is associated with the audio function, and the data transmission management module is further arranged to allocate a portion of the transmission bandwidth to the audio function.

18. The communication device of claim 12, wherein the requirement information comprises the audio information, the audio information indicates that an audio function is disabled, the attribute information is associated with the audio function, and the data transmission management module is further arranged to transmit the multiple data to the reception device by utilizing a bandwidth corresponding to the audio function in the transmission bandwidth.

19. The communication device of claim 11, wherein the specific interface is an Ethernet or an optical fiber.

20. The communication device of claim 19, wherein the specific interface is the optical fiber, and the requirement information comprises at least one of video information, audio information, auxiliary data information, and Ethernet information.
